(19) United States
(12) Patent Application Publication
(10) Pub. No.: US 2012/0124521 A1
(43) Pub. Date: May 17, 2012

(54) ELECTRONIC DEVICE HAVING MENU AND DISPLAY CONTROL METHOD THEREOF

(75) Inventor: XIN GUO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/220,808

(22) Filed: Aug. 30, 2011

(30) Foreign Application Priority Data
Nov. 16, 2010 (CN) 201010545727.X

(51) Int. Cl. G06F 3/048

(52) U.S. Cl. 715/834

(57) ABSTRACT

An electronic device includes a graphical user interface, a display unit, a moving unit, an input unit, and a processor. The graphical user interface includes a menu. The menu includes a main menu having at least one main option. The display unit defines a first displaying region for displaying the at least one main option of the main menu and a selecting region in the first displaying region. The moving unit is used for moving the at least one main option in the display unit. The input unit is operable by users for generating an input signal accordingly. The processor selects the selected main option which is moved to be displayed in the selecting region in response to the input signal.

### BACKGROUND

1. Technical Field

The present disclosure relates to an electronic device and a display control method for controlling the display of a menu of the electronic device.

2. Description of Related Art

Many electronic devices often include graphical user interfaces (GUIs) for allowing users to operate the electronic devices. The GUI usually includes a menu having a plurality of main options, and each main option may be expanded to form a sub-menu having a plurality of sub-options. However, in use, the menu may extend to several pages with main options and sub-options of each sub-menu being distributed over the pages. This is inconvenient for users and may result in the frequent movement of a finger or a touch object when users touch the display device for selecting the desired option.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device according to an embodiment of the present disclosure.

FIG. 2 is a schematic view of the menu of the electronic device of FIG. 1.

FIG. 3 is a detailed schematic view of the menu of FIG. 2.

FIG. 4 is a flow chart of a method for controlling the displaying of the menu of FIG. 1.

### DETAILED DESCRIPTION

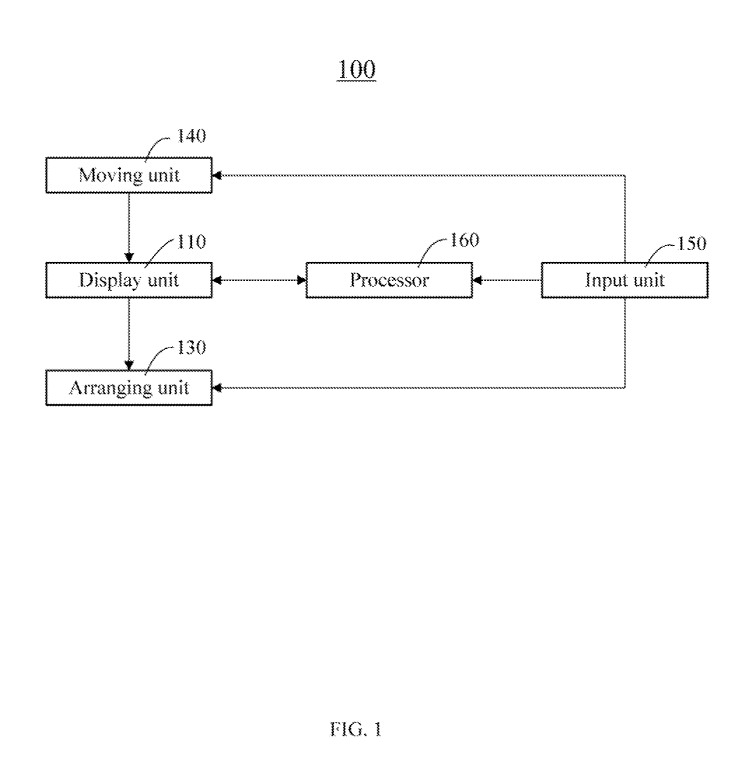

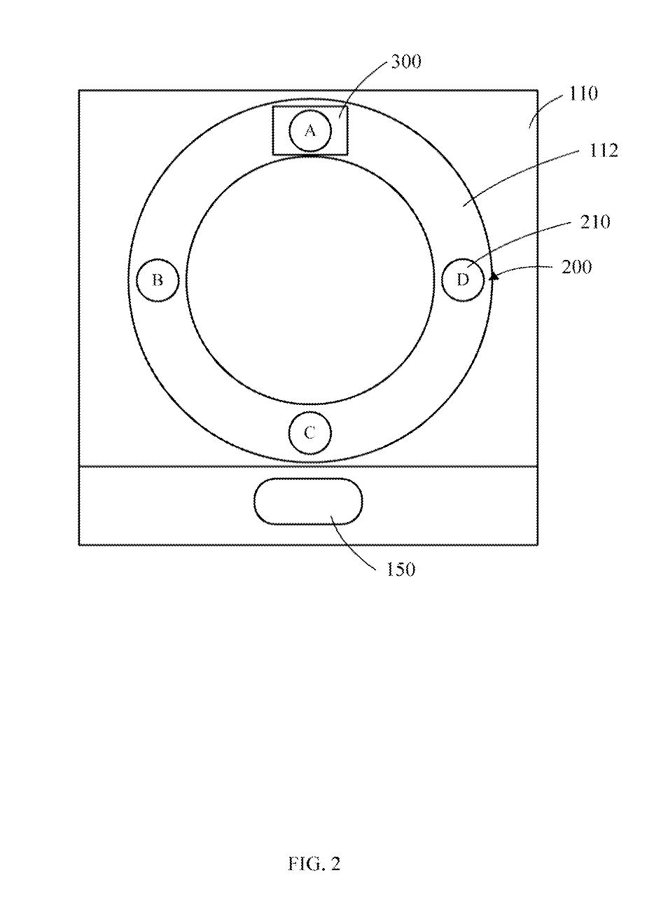

Referring to FIG. 1 and FIG. 2, an electronic device 100 includes a display unit 110, an arranging unit 130, a moving unit 140, an input unit 150, and a processor 160. In some embodiments, the electronic device 100 may be a notebook computer, a mobile phone, a music player, or other electronic devices having displaying functions.

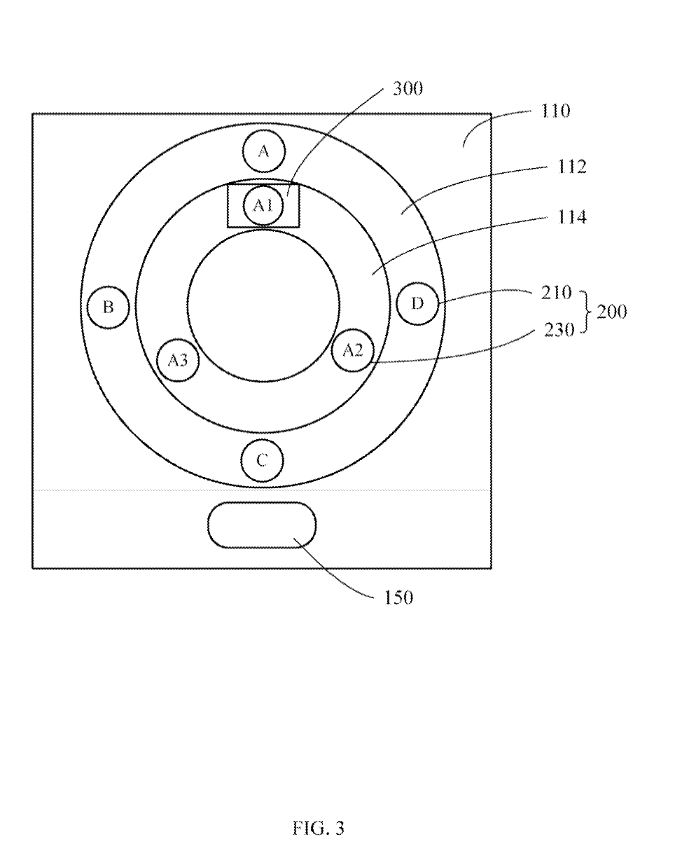

The display unit 110 is capable of displaying a graphical user interface (GUI, not labeled) of the electronic device 100. In some embodiments, the GUI of the electronic device 100 may include windows, icons, menus, or pointing devices of the electronic device 100. In the illustrated embodiment, the GUI includes a menu 200 for guiding users to desired options so that desired control functions of the electronic device 100 can be executed when the desired options are selected. The menu 200 includes a main menu 210 having a list of main options. Each main option may be expanded to form a sub-menu having a list of sub-options. The main options and sub-options may be represented with letters. Referring to FIG. 3 also, in the embodiment, letters A, B, C, D are used for representing the main options, and letters A1, A2, A3 are used for representing the sub-options of the sub-menu 230 of the main option A.

The display unit 110 defines a first annular displaying region 112, a second annular displaying region 114, and a selecting region 300. The first displaying region 112 is used for displaying the main menu 210, and the second displaying region 114 is used for displaying the sub-menu 230 of the one of main options selected by a user. In some embodiments, the first displaying region 112 and the second displaying region 114 can both be displayed in the display unit 110 at the same time, or, in other embodiments, only one of the first and second displaying regions 112, 114 is displayed in the display unit 110 at one time. In the illustrated embodiment, both the first displaying region 112 and the second displaying region 114 are displayed in the display unit 110 at the same time, and the second displaying region 114 is surrounded by the first displaying region 112. The selecting region 300 is capable of being operatively displayed in the first displaying region 112 or in the second displaying region 114 for allowing one of the main options or sub-options to be displayed therein and selected by the user.

The arranging unit 130 is electrically connected to the display unit 110 for evenly spacing the main options in the first displaying region 112 and the sub-options of each sub-menu 230 in the second displaying region 114. The arranging unit 130 is further used for operatively displaying the selecting region 300 in the first displaying region 112 or the second displaying region 114.

The moving unit 140 is electrically connected to the display unit 110 for successively moving the main menu 210 and each sub-menu 230 such that each main option and each sub-option can be moved to be displayed in the selecting region 300. In the embodiment, the moving unit 140 respectively rotates the main options of the main menu 210 in the first displaying region 112 and the sub-options of each sub-menu 230 in the second displaying region 114 at a constant speed.

The input unit 150 is electrically connected to the arranging unit 130 and the moving unit 140, and is used for operatively generating input signals in response to users' operations. In the illustrated embodiment, the input unit 150 may include a push button. The input unit 150 generates the input signals when being pressed. In other embodiments, the input unit 150 may be a main option of the main menu 210 or a sub-option of each sub-menu 230 which is capable of being selected by users.

The processor 160 is electrically connected to the display unit 110 and the input unit 150, and is used for selecting one of the main options of the main menu 210, which is then moved to be displayed in the selecting region 300 in response to the input signal, and expanding the sub-menu of the selected main option in the second displaying region 114. In the illustrated embodiment, the processor 160 compares the positions of each main option and that of the selecting region 300 to obtain the selected main option.

It should be understood that in other embodiments, if the menu 200 has more than two sub-menus, the displaying region 400 can be divided into more than two displaying regions according to the number of the sub-menus.

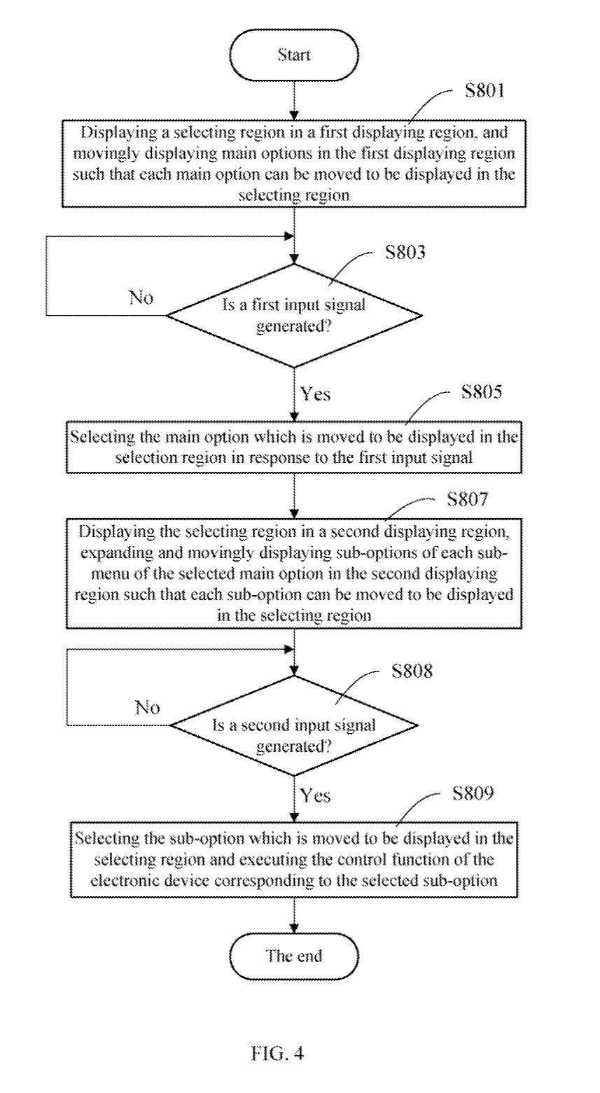

Referring to FIG. 4, a display control method applied in the electronic device 100 is provided for controlling the display of the GUI of the electronic device 100 in the display unit 110. In the illustrated embodiment, the GUI includes a menu 200 and the display control method controls the display of the menu 200. The menu 200 includes a main menu 210 and a list of sub-menus 230. The main menu 210 includes a number of main options labeled as A, B, C, D shown in FIGS. 2 and 3, and each main option may be expanded to form a sub-menu 230. Each sub-menu 230 also includes a number of sub-options labeled as A1, A2, A3. The display unit 110 defines a first displaying region 112 for displaying the main menu 112, a second displaying region 114 for displaying each sub-menu 230, and a selecting region 300 capable of being operatively arranged to be displayed in the first or second displaying regions 112, 114. In some embodiments, both the first and second displaying regions 112, 114 are annular for allowing options of main menu 210 and each sub-menu 230 to be rotated therein.

The display control method includes the following steps:

In step S801, displaying the selecting region 300 in the first displaying region 112, movingly displaying the main options of the main menu 210 in first displaying region 112 for allowing each main option to be moved to be displayed in the selecting region 300. In the illustrated embodiment, the main options of the main menu 210 are capable of being rotated in the first displaying region 112 at a constant speed.

In step S803, determining whether a first input signal is generated or not. If the first input signal is generated, the step S805 is implemented. If no input signal is generated, return to the step S803.

In step S805, selecting the main option of the main menu which is moved to the selecting region 300 in response to the first input signal. That is, in step S805, the one of the main options being selected by users is obtained. In the illustrated embodiment, the position of the selecting region 300 is compared with the position of each main option to obtain the selected main option.

In step S807, expanding and movingly displaying the sub-menu 230 of the selected main option in the second displaying region 114. The selecting region 300 is operatively arranged to be displayed in the second displaying region 114. In the illustrated embodiment, the sub-options of each sub-menu 230 are capable of being rotated in the second displaying region 114 at a constant speed.

In step S808, determining whether a second input signal is generated. If the second input signal is generated, the step S809 is implemented. If no input signal is generated, return to the step S808.

In step S809, obtaining the one of the sub-options which is moved to the selecting region 300 in the second displaying region 114 in response to the second input signal and executing the control function of electronic device 100 corresponding to the selected sub-option.

With the electronic device 100 and the display control method thereof, users can operate the input unit 150 to select the desired main option or sub-option as the main options or the sub-option moves in the displaying unit 110. Therefore, users can execute functions of the electronic device without excessive movement of their finger or a touch object.

It is to be understood, however, that even though information and the advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A electronic device, comprising:
a graphical user interface comprising a menu, the menu comprises a main menu having at least one main option;
a display unit defining a first displaying region for displaying the at least one main option and a selecting region in the first displaying region;
a moving unit for moving the at least one main option in the display unit and allowing the at least one icon to be moved to the selecting region;
an input unit being operable by users for generating an input signal accordingly; and
a processor for selecting one of the at least one main option which is moved to be displayed in the selecting region in response to the input signal.

2. The electronic device as claimed in claim 1, wherein the at least one main option moves in the first displaying region at a constant speed and the moving speed of the at least one main option is capable of being set by a user.

3. The electronic device as claimed in claim 1, wherein the electronic device further comprises an arranging unit for evenly spacing the at least one main option in the first displaying region.

4. The electronic device as claimed in claim 3, wherein each main option can be expanded to form a sub-menu comprising at least one sub-option, the display unit further defines a second displaying region for displaying the at least one sub-option of each sub-menu, and the arranging unit is further used for operatively displaying the selecting region in the second displaying region.

5. The electronic device as claimed in claim 4, wherein the arranging unit further evenly spaces the at least one sub-option of each sub-menu in the second displaying region.

6. The electronic device as claimed in claim 4, wherein the moving unit moves the at least one sub-option of each sub-menu in the second displaying region such that each sub-option can be moved to be displayed in the selecting region.

7. The electronic device as claimed in claim 6, wherein the at least one sub-option of each sub-menu moves in the second displaying region at a constant speed.

8. The electronic device as claimed in claim 4, wherein the first displaying region and the second displaying region are capable of displaying the main menu and the corresponding sub-menu at the same time.

9. The electronic device as claimed in claim 8, wherein both the first displaying region and the second displaying region are annular, and the second displaying region is surrounded by the first displaying region.

10. The electronic device as claimed in claim 1, wherein the processor selects the main option of the main menu which is moved to be displayed in the selecting region by comparing the positions of each main option and the position of the selecting region.

11. A display control method for controlling the display of a graphical user interface of an electronic device, the graphical user interface comprises a menu, the menu comprises a main menu having at least one main option, the electronic device comprises a display unit defining a first displaying region for displaying the main menu and a selecting region capable of being operatively arranged to be displayed in the first displaying region, and the display control method comprises the following steps:
displaying the selecting region in the first displaying region and movingly displaying the at least one main option of the main menu in the first displaying region;
determining whether a first input signal is generated; and
selecting the main option which is moved to be displayed in the selecting region in response to the first input signal.

12. The display control method as claimed in claim 11, wherein the at least one main option is evenly-spaced in the first displaying region and is capable of being rotated in the first displaying region at a constant speed.

13. The display control method as claimed in claim 11, wherein the display control method further comprises the step:
if no input signal is generated, return to the step of judging whether a first input signal is generated.

14. The display control method as claimed in claim 11, wherein each main option can be expanded to form a sub-menu comprising at least one sub-option, the display unit further defines a second displaying region for displaying the sub-menu of each main option, and the display control method further comprises the following step:
displaying the selecting region in the second displaying region in response to the first input signal;
expanding the sub-menu of the selected main option and movingly displaying the sub-menu in the second displaying region.

15. The display control method as claimed in claim 14, wherein the at least one sub-option is evenly-spaced in the second displaying region and is capable of being rotated in the second displaying region at a constant speed to be displayed in the selecting region.

16. The display control method as claimed in claim 14, wherein the display control method further comprises the following step:
determining whether a second input signal is generated;
selecting the sub-option which is moved to be displayed in the selecting region in the second displaying region in response to the second input signal;
executing the control function corresponding to the selected sub-option.

17. The display control method as claimed in claim 14, wherein the second displaying region is the same as the first displaying region.

18. The display control method as claimed in claim 14, wherein the second displaying region is surrounded by the first displaying region.

19. The display control method as claimed in claim 18, wherein both the first displaying region and the second displaying region are annular.
